(19) United States
(12) Patent Application Publication
(10) Pub. No.: US 2014/0366669 A1
(43) Pub. Date: Dec. 18, 2014

(54) TRANSMISSION PLATE

(71) Applicant: David J. Goerend, Saint Lucas, IA (US)

(72) Inventor: David J. Goerend, Saint Lucas, IA (US)

(21) Appl. No.: 14/303,811

(22) Filed: Jun. 13, 2014

Related U.S. Application Data
(60) Provisional application No. 61/834,492, filed on Jun. 13, 2013.

(51) Int. Cl. F16H 61/02

(52) U.S. Cl. CPC F16H 61/0267; F16H 61/0276
USPC 74/473.11

(57) ABSTRACT

A transmission plate is provided for use on both a diesel transmission casting and a gasoline transmission casting. The plate includes a continuous perimeter edge without a perimeter oil flow notch to inhibit firm shifting of a torque converter connected to the transmission. The plate also has one or more pockets formed therein to reside above a wall of the transmission casting and thereby permit fluid flow over the wall without the need to drill a hole through the wall of the casting. The plate further includes a solid portion free from an oil flow hole so as to preclude fluid flow from a fluid cavity in the transmission casting and thereby preventing downshifting from second gear to first gear by the transmission.

### CROSS-REFERENCE TO RELATED APPLICATIONS

This application claims priority under 35 U.S.C. §119 to provisional application Ser. No. 61/834,492 filed Jun. 13, 2013, herein incorporated by reference in its entirety.

### BACKGROUND OF THE INVENTION

Conventional automatic transmissions include an aluminum casting with a cover plate which defines numerous labyrinth paths for the hydraulic fluid flow during shifting of the transmission through the first, second, third, and fourth gears. The castings for gasoline and diesel engines have different perimeter outlines, such that different cover plates are required for each engine to match the perimeter edges. In particular, a gasoline transmission casting has a stepped out edge with an enlarged through port, as compared to the straight perimeter edge and smaller opening of a diesel transmission casting. Also, the castings are sometimes modified to change or enhance the fluid flow during shifting. For example, holes may be drilled through casting walls to change the fluid flow. However, such drilling creates aluminum shavings which must be removed before the transmission is put into use, but can be difficult to clean out.

Conventional plates for both gasoline and diesel transmissions also normally include a notch at a perimeter edge which provides an exhaust oil path for a torque converter, which can produce an overly firm shift to the lock up condition. Other conventional holes in transmission plates can also produce damaging downshifts from third to first gears at certain speeds.

Therefore, there is a need for an improved transmission assembly which overcomes the problems of the prior art.

Accordingly, a primary objective of the present invention is a provision of a transmission plate which can be used with both diesel and gasoline engine transmission castings.

Another objective of the present invention is the provision of a transmission plate which eliminates the need to drill holes through casting walls while permitting modified fluid flow through the casting.

Still another objective is the provision of an improved transmission plate which reduces and/or eliminates undesirable shifting of the transmission and torque converter.

A further objective of the present invention is the provision of an improved transmission plate which improves performance of the transmission.

These and other objectives will become apparent from the following description of the invention.

### BRIEF DESCRIPTION OF THE PHOTOGRAPHS AND DRAWINGS

FIG. 1 shows the multi-purpose transmission plate of the present invention which will fit either a diesel or gasoline casting of an automatic transmission case.

FIG. 2 shows a portion of a conventional transmission plate, including a notch in the upper perimeter and a through hole.

FIG. 3A shows a portion of the transmission plate of the present invention taken along line 3 of FIG. 1.

FIG. 3B shows a portion of a conventional gasoline transmission plate, with the stepped out lower right perimeter edge, which does not fit a diesel transmission.

FIG. 3C shows a portion of a conventional diesel transmission plate, with a straight lower right perimeter edge, which will not fit a gasoline transmission.

### DESCRIPTION OF THE INVENTION

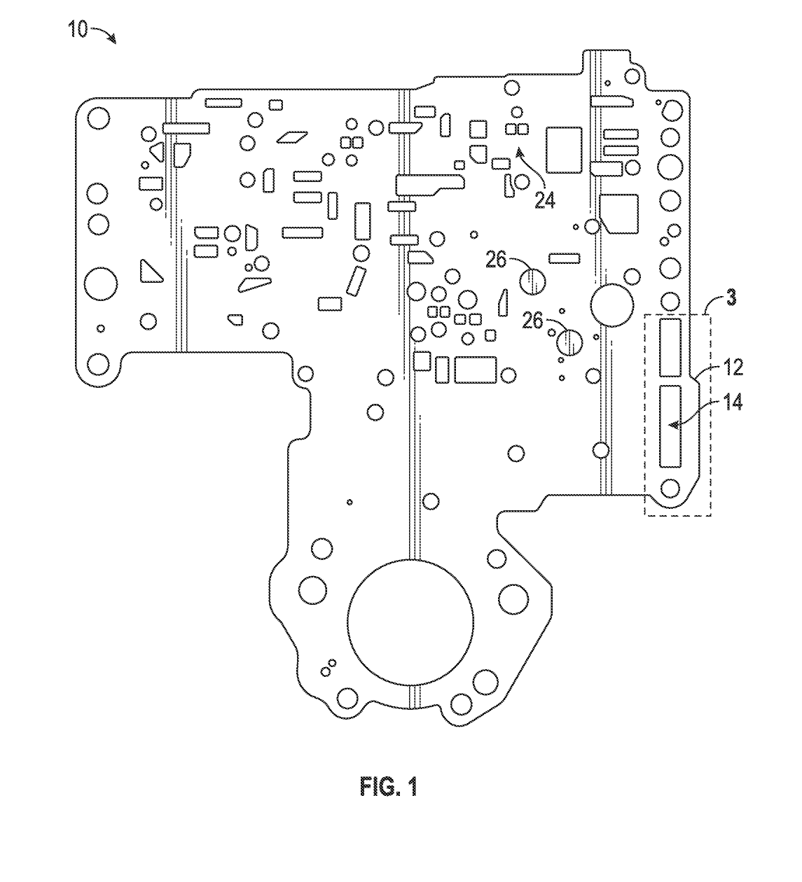

The improved transmission plate 10 of the present invention is shown in FIGS. 1 and 3A. This improved transmission plate 10 can be used on both a diesel engine transmission casting and a gasoline engine transmission casting, due to the configuration of the plate.

More particularly, as seen in FIG. 1, the transmission plate 10 includes a stepped out perimeter portion 12 and a rectangular opening 14 which, together, allow the plate 10 to be used on a diesel casting and/or on a gasoline casting. As seen in FIG. 3C, the lower right perimeter edge of the diesel plate 10D is straight, whereas the lower right perimeter wall of the gasoline plate 10G is stepped out, as shown in FIG. 3B. The different designs of the fluid cavities (not shown) in conventional diesel and gasoline castings precludes conventional transmission plates 10D, 10G from being used on both castings. FIG. 3B shows a conventional gasoline transmission plate 10G having a stepped out lower perimeter edge 12G and an enlarged rectangular opening 14G to accommodate the enlarged or extended wall of the gasoline cavity fluid cavity. In comparison, the convention diesel transmission plate 14D shown in FIG. 3C has a straight right edge 12D with a smaller rectangular opening 14D to match the smaller diesel casting fluid recess. In FIG. 3B, the dotted or broken line 16 represents the wall of the comparable diesel fluid cavity, and shows how the conventional gasoline plate 10G will not fit the diesel casting. Similarly, in FIG. 3C, the dotted or broken line 18 represents the extended or enlarged fluid cavity of the gasoline casting, and illustrates how the convention diesel plate 10D will not match the gasoline casting. The stepped out portion 12 of the improved transmission plate 10 and the reduced size rectangular opening 14 allows Applicant's plate 10 to be used on both the diesel casting and the gasoline casting, as shown in FIGS. 1 and 3A.

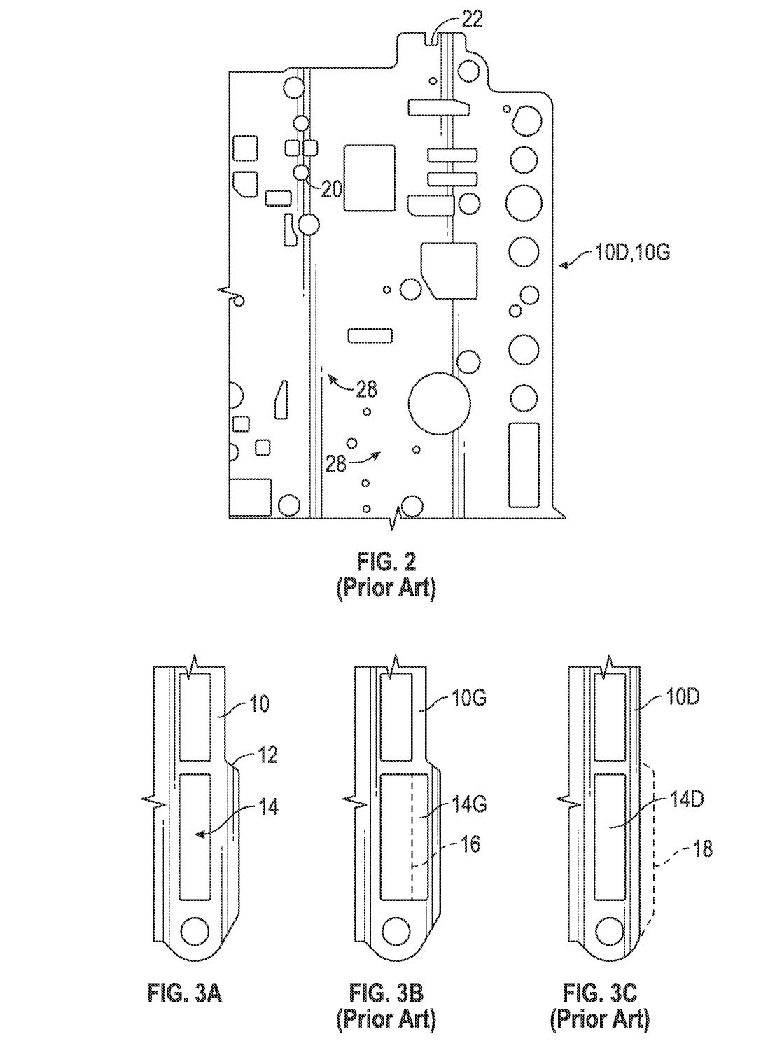

FIG. 2 shows a portion of a conventional transmission plate 10D or 10G (comparable to the upper right corner of Applicant's plate 10 shown in FIG. 1) having a hole 20 and a perimeter notch 22. The hole 20 produces an undesirable downshift from third to first gears when a vehicle is traveling at approximately 40 miles per hour using 3/4 throttle when the ECM changes governor pressure to 20 PSI. Such a shift can damage the engine. In Applicant's improved transmission plate shown in FIG. 1, the hole 20 is eliminated, as designated by the arrow 24 in FIG. 1. Applicant's plate eliminates the hole 20 to preclude oil flow to the right side of the 1-2 shift valve, and thereby avoid or eliminate shift damage.

The notch 22 in the perimeter edge of the conventional transmission plate 10D, 10G shown in FIG. 2 provides an exhaust path for the front oil of a torque converter (not shown). It is known to drill holes in the casting walls adjacent the slot or notch 22 so as to increase the fluid flow from the torque converter. When oil is exhausted through the slot 22 in the conventional transmission plate, the pressure adjacent the converter is reduced so that the plate moves into engagement with the friction facing so as to lock the torque converter. If oil is exhausted too quickly through the slot 22, a hard or jolting shift occurs, which is undesirable. Applicant's improved transmission plate 10 eliminates the slot 22 of a conventional transmission plate, thereby reducing the fluid flow from the torque converter, so that the oil or fluid flow will exit the transmission casting only through the holes. This reduced fluid flow will soften the converter shift into lockup. Otherwise, the holes in the casting would have to be plugged so as to reduce the fluid flow and soften the shift.

It is also known to drill holes through the casting walls to allow a fluid flow between the casting cavities. However, the drilling of such holes produces aluminum shavings and dust which is difficult to clean from the cavities and will lead to damage. To avoid damage which may be caused by the shavings and dust, the transmission plate 10 of the present invention has recessed pockets 26 formed on the inside surface, as shown in FIG. 1. The pockets 26 allow fluid flow over the casting walls into adjacent cavities and eliminate the need for drilling holes in the casting walls. The pockets do not extend through the plate 10. Conventional transmission plates do not have such recessed pockets for fluid flow between casting cavities. For comparison, see the similar area of the plate 10D in FIG. 2, at arrows 28, where the inside surface of the plate is planar and free of recesses or pockets.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A transmission plate for use with a transmission casting of an automatic transmission, comprising:
a stepped out perimeter portion to match a stepped perimeter edge of a diesel transmission; and
a rectangular opening adjacent the stepped out perimeter portion to match a rectangular cavity of a gasoline transmission casting;
whereby the plate can be used on both the diesel transmission casting and the gasoline transmission casting.

2. The transmission plate of claim 1 further comprising a continuous perimeter edge without a perimeter oil flow notch to inhibit firm shifting of a torque converter operatively connected to the casting.

3. The transmission plate of claim 1 further comprising a pocket formed on an inside surface thereof to reside above a wall of the transmission casting and thereby permit fluid flow over the wall without need for a hole in the wall of the casting.

4. The transmission plate of claim 1 further comprising a solid plate portion free from an oil flow hole, so as to preclude fluid flow from a fluid cavity in the transmission casting and thereby prevent downshifting from second gear to first gear.

5. A transmission plate for use with a transmission casting of an automatic transmission, comprising:
a continuous perimeter edge without a perimeter oil flow notch to inhibit firm shifting of a torque converter operatively connected to the casting.

6. The transmission plate of claim 5 further comprising:
a stepped out perimeter portion to match a stepped perimeter edge of a diesel transmission; and
a rectangular opening adjacent the stepped out perimeter portion to match a rectangular cavity of a gasoline transmission casting;
whereby the plate can be used on both the diesel transmission casting and the gasoline transmission casting.

7. The transmission plate of claim 5 further comprising a pocket formed on an inside surface thereof to reside above a wall of the transmission casting and thereby permit fluid flow over the wall without need for a hole in the wall of the casting.

8. The transmission plate of claim 5 further comprising a solid plate portion free from an oil flow hole, so as to preclude fluid flow from a fluid cavity in the transmission casting and thereby prevent downshifting from second gear to first gear.

9. A transmission plate for use with a transmission casting of an automatic transmission, comprising:
a pocket formed on an inside surface of the plate to reside above a wall of the transmission casting and thereby permit fluid flow over the wall without need for a hole in the wall of the casting.

10. The transmission plate of claim 9 further comprising:
a stepped out perimeter portion to match a stepped perimeter edge of a diesel transmission; and
a rectangular opening adjacent the stepped out perimeter portion to match a rectangular cavity of a gasoline transmission casting;
whereby the plate can be used on both the diesel transmission casting and the gasoline transmission casting.

11. The transmission plate of claim 9 further comprising a continuous perimeter edge without a perimeter oil flow notch to inhibit firm shifting of a torque converter operatively connected to the casting.

12. The transmission plate of claim 9 further comprising a solid plate portion free from an oil flow hole, so as to preclude fluid flow from a fluid cavity in the transmission casting and thereby prevent downshifting from second gear to first gear.

13. A transmission plate for use with a transmission casting of an automatic transmission, comprising:
a solid plate portion free from an oil flow hole, so as to preclude fluid flow from a fluid cavity in the transmission casting and thereby prevent downshifting from second gear to first gear.

14. The transmission plate of claim 13 further comprising:
a stepped out perimeter portion to match a stepped perimeter edge of a diesel transmission; and
a rectangular opening adjacent the stepped out perimeter portion to match a rectangular cavity of a gasoline transmission casting;
whereby the plate can be used on both the diesel transmission casting and the gasoline transmission casting.

15. The transmission plate of claim 13 further comprising a continuous perimeter edge without a perimeter oil flow notch to inhibit firm shifting of a torque converter operatively connected to the casting.

16. The transmission plate of claim 13 further comprising a pocket formed on the inside surface thereof to reside above a wall of the transmission casting and thereby permit fluid flow over the wall without need for a hole in the wall of the casting.
